(19) United States
(12) Patent Application Publication
(10) Pub. No.: US 2012/0141238 A1
(43) Pub. Date: Jun. 7, 2012

(54) BARREL TRUCK

(76) Inventor: Greg McFarland, Astoria, NY (US)

(21) Appl. No.: 13/311,161

(22) Filed: Dec. 5, 2011

Related U.S. Application Data
(60) Provisional application No. 61/420,052, filed on Dec. 6, 2010.

(51) Int. Cl. B62B 1/26

(52) U.S. Cl. 414/444

(57) ABSTRACT

A barrel truck comprising a handle, a wheeled support coupled to the handle, wheels of the support being spaced apart on the support to receive a barrel to be lifted therebetween, the handle being fixedly coupled to the wheeled support, a member coupled to the wheeled support for engaging with a rib of the barrel, and the member adapted to have a force applied thereto to exert an upward force on the rib of the barrel to lift the barrel off the ground in order to move the barrel on the wheeled support, the force being applied to the member by pivoting the handle with a vertical motion.

### RELATED APPLICATIONS

This application claims the benefit of U.S. Provisional Application No. 61/420,052, filed Dec. 6, 2010, the entire disclosure of which is incorporated by reference herein.

### BACKGROUND OF THE INVENTION

This invention relates to barrel trucks for handling and moving barrels or drums.

Conventional barrel trucks typically are wheeled devices that are used to lift a barrel from the end of the barrel along a pivot that is not near the center of the barrel. For example, U.S. Pat. No. 4,106,648 uses a clamping device that clamps to the upper lip of the barrel. Then the barrel truck is pivoted to raise the barrel off the ground. However, the pivoting occurs from near the edge of the barrel making it more difficult to lift the barrel because it is not being lifted near its center. Also, see U.S. Pat. No. 5,042,962 which shows a barrel mover wherein the fulcrum point is near the edge of the barrel, also making it more difficult to lift.

Barrel trucks that engage a rib of a barrel to lift the barrel are also known. However, these known barrel trucks typically have a pivotable handle that operates a lever arrangement to raise engagement members that grip the barrel near the rib. The present invention provides a simpler barrel truck that has fewer parts and is less costly to manufacture.

For example, barrel or drum trucks of this more costly and complex design are shown in brochures of Optimal Handling Solutions, L.K. Godwin Co. and Wesco.

### SUMMARY OF THE INVENTION

According to the present invention, the barrel truck lifts the barrel near the center of the barrel by engaging a rib of the barrel. Preferably, the barrel truck has no moving parts, except the wheels. Barrels customarily are formed with corrugated ribs to increase their strength. The present invention has engaging members that engage a rib or underneath a rib of the barrel to allow lifting the barrel off the ground with the fulcrum point near the center of the barrel. The invention is applicable to any barrel having a circumferential rib or ribs of various shapes and sizes.

### BRIEF DESCRIPTION OF THE DRAWINGS

FIG. 1 shows a side view of the invention;

FIG. 2 shows a view of the barrel truck engaging a barrel;

FIG. 3 shows a side view of the barrel truck while in use, beginning to engage a barrel;

FIG. 3A and 3B show details of the barrel truck;

FIG. 4 shows the barrel truck lifting a barrel; and

FIG. 5 shows a top view.

### DETAILED DESCRIPTION OF THE INVENTION

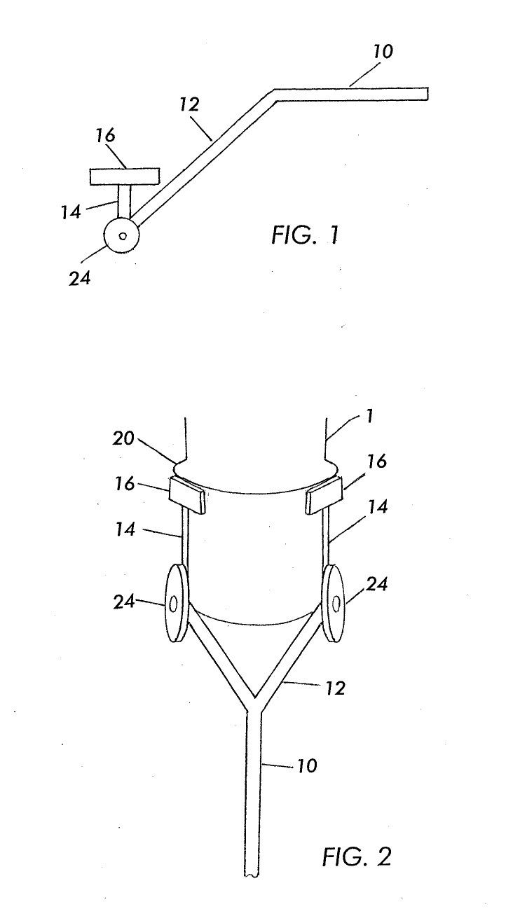

FIG. 1 shows a side view of the barrel truck according to the invention. FIG. 2 shows a view of the barrel truck engaging a barrel 1. The barrel truck includes a handle 10 that extends into a fork 12. The fork 12 extends into two upwardly extending arms 14 that are spaced apart substantially the standard distance of a barrel (typically 55 gal. drum), preferably providing a snug fit with the barrel. The arms 14 are attached to or integrally formed with perpendicular engaging elements 16 that engage a rib 20 of a barrel. The arms 14 are disposed above the axis of individually mounted wheels 24. FIG. 2 shows the engagement at the lowest rib 20 of a barrel. However, the engaging members 16 could engage other ribs of the barrel instead.

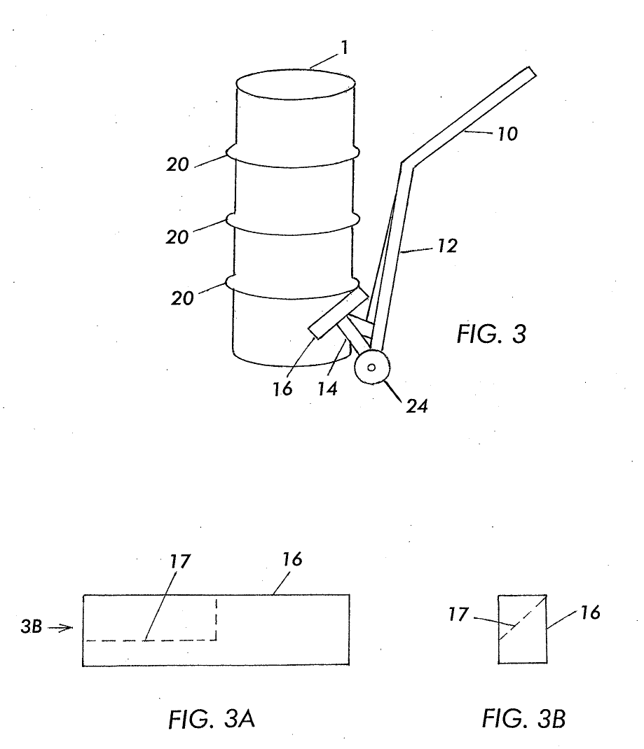

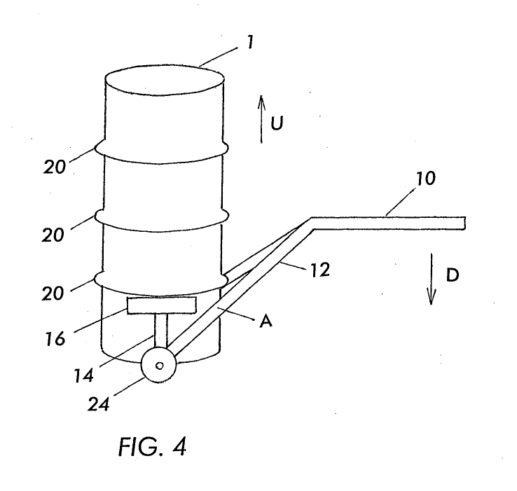

FIGS. 3 and 4 show the barrel truck in use. The barrel truck is moved so that the engaging members 16 are initially disposed at an angle to and adjacent a rib 20 of the barrel. The members 16 preferably have a snug fit against the barrel. The members 16 may have a partially chamfered edge to allow wedging against the rib 20 when in the initial angled position shown in FIG. 3. For example, the members 16 may be shaped to have a partial chamfer 17 as shown in the top view of FIG. 3A at their forward edges to wedge against the rib 20. FIG. 3B shows the chamfer 17 from the front. Alternatively, the member 16 can have a U shape or other shape to fit the rib. The upwardly extending members 14, members 16 and members 10 and 12 are made of sufficiently strong metal such as steel. The members 14 are fixed in position with respect to the forked arms 12. The members 14 maintain a fixed distance between them equal to the diameter of a barrel, but less than the diameter of the barrel at the rib 20. The barrel truck is moved into the position as shown in FIG. 3 so that the arms 16 are disposed at an angle with respect to the rib 20. The barrel truck is pushed against the barrel so that the engaging members 16 wedge into contact with the barrel and begin to engage underneath rib 20 near the center of the barrel. At this point, as shown in FIG. 4, the barrel truck is pivoted by pivoting the handle 10 downwardly as shown by arrow D. This causes the engaging members 16 to engage with the underside of the rib 20 and lift the barrel as shown by arrow U. When in the horizontal position, the distance of the top of the engaging members 16 from the ground is sufficiently more than the distance between the bottom of the rib 20 and the ground on which the barrel is resting so as to raise the barrel from the ground. The pivoting motion thereby causes the barrel to be raised off the ground. Since the pivot point or fulcrum is located along the axis of the wheels 24, which is near the center of the barrel, the barrel is easier to lift off the ground than are barrels lifted by the conventional barrel trucks which have the fulcrum point at the edge of the barrel. The arms or uprights 14 can be made to be adjustable in length to facilitate lifting barrels having different height ribs.

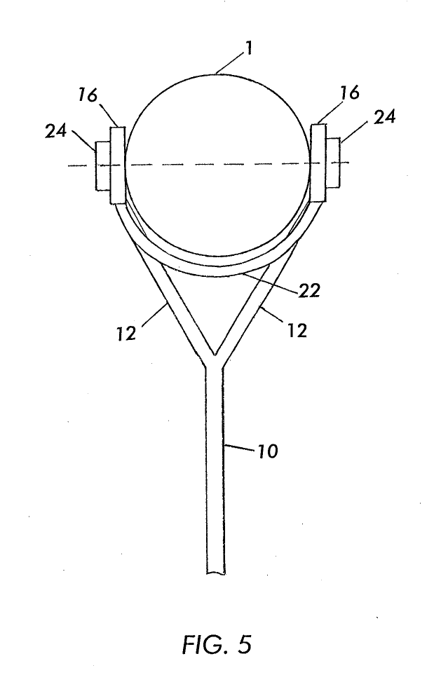

It is important that the distance between the engaging members 16 remain substantially constant, i.e., there be little or no flex between the engaging members so that the engaging members tightly grasp the rib 20 of the barrel. This distance can be maintained by making the barrel truck out of a suitably strong metal so that the upright members 14 have little or no flex. Alternatively, a tie rod 22 as shown in the top view of FIG. 5 can be employed that connects the members 16 together. The tie rod is curved so that it has the curvature of a barrel. A curved tie rod will hold the engaging elements 16 in position and will not interfere with the barrel. Alternatively, instead of a fixed tie rod 22, a chain or cable can be employed connecting the engaging members 16. Once the barrel truck is in position engaging a barrel, the chain or cable will engage the barrel and prevent the engaging members 16 from splaying apart when the barrel is lifted.

A chain or cable can also be provided at the front of the barrel between the members 16 placed after the barrel truck is moved into position to ensure that the barrel does not topple over in the forward direction. Alternatively, a locking member can be employed as in the prior art to fix the barrel to the barrel truck.

The barrel as shown has no moving parts with the exception of the wheels, that is, the handle 10, fork arms 12, uprights 14 and engaging members 16 are fixed with respect to each other. There are no moving parts with the exception of the wheels and, if uprights 14 are adjustable, these uprights. The fixed parts can be made integral, forged, cast, welded or bolted together, etc.

According to the invention, by placing the fulcrum near the center of the barrel, near the axis of the wheels, the barrel is easier to lift off the ground using a simple pivoting motion of the handle. Further, according to the invention, the barrel truck engages a rib or ribs of the barrel to lift the barrel near the center line of the barrel, thereby allowing easier lifting of the barrel from the ground. The provision for lifting the barrel by a rib 20 allows the barrel truck, according to the invention, to have a fulcrum point for pivoting the barrel near the center of the barrel. As shown in FIG. 4, when the barrel is lifted from the ground and being supported by the members 16 and on the wheels 24 of the barrel truck, the arms 12 can be designed to engage the perimeter of the barrel at A (FIG. 4) to provide increased stability when the barrel is moved on the barrel truck.

What is claimed is:

1. A barrel truck comprising:
a handle;
a wheeled support coupled to the handle, wheels of the support being spaced apart on the support to receive a barrel to be lifted therebetween;
the handle being fixedly coupled to the wheeled support;
a member coupled to the wheeled support for engaging with a rib of the barrel, the member adapted to have a force applied thereto to exert an upward force on the rib of the barrel to lift the barrel off the ground in order to move the barrel on the wheeled support, the force being applied to the member by pivoting the handle with a vertical motion.

2. The barrel truck of claim 1, wherein the member comprises an upright disposed for positioning on opposed sides of the barrel, each upright having a perpendicularly disposed member adapted to grasp the rib or below the rib, the perpendicularly disposed member being fixedly secured to the upright, the upright being secured to the wheeled support whereby the handle forms an angle with the upright, the handle being pivoted downwardly when the perpendicularly disposed member is positioned against the rib at approximately a center of the barrel thereby causing the perpendicularly disposed member to pivot into engaged alignment with the rib to grasp the barrel and move upwardly to lift the barrel from the ground.

3. The barrel truck of claim 2, wherein the perpendicularly disposed members are initially disposed at an angle with respect to the rib before the handle is pivoted downwardly, and after downward pivoting of the handle, are disposed in alignment with the rib.

4. The barrel truck of claim 2, wherein the upright is adjustable vertically to adjust to barrel ribs of different heights from the ground.
